(19) United States
(12) Patent Application Publication
(10) Pub. No.: US 2024/0185595 A1
(43) Pub. Date: Jun. 6, 2024

(54) METHOD FOR EVALUATING QUALITY OF POINT CLOUD MAP BASED ON MATCHING

(71) Applicant: Beihang University, Beijing (CN)

(72) Inventors: Zhipeng WANG, Beijing (CN); Hongxia WANG, Beijing (CN); Kun FANG, Beijing (CN); Jiahao XU, Beijing (CN); Zhiqiang DAN, Beijing (CN)

(73) Assignee: Beihang University, Beijing (CN)

(21) Appl. No.: 18/138,139

(22) Filed: Apr. 24, 2023

(30) Foreign Application Priority Data
Dec. 5, 2022 (CN) 202211548632.2

(51) Int. Cl. G06V 10/98; G06V 10/75

(52) U.S. Cl. CPC G06V 10/993; G06V 10/757

(57) ABSTRACT

A method for evaluating quality of a point cloud map based on matching includes the following steps: S1, acquiring the to-be-evaluated point cloud map as a point cloud matching algorithm input; S2, acquiring a point cloud sample set for matching; S3, matching by using a point cloud matching algorithm, and iterating to obtain estimated three-dimensional coordinate system transforms; S4, calculating point cloud matching errors; and S5, taking an obtained quality evaluation score of the to-be-evaluated point cloud map as a point cloud matching algorithm output. The method for evaluating the quality of the point cloud map based on matching can evaluate the quality of the point cloud map in a full-automatic manner without the dependence on truth values and artificial calibration, so as to improve the quality evaluation efficiency of the point cloud map.

### CROSS REFERENCE TO THE RELATED APPLICATIONS

This application is based upon and claims priority to Chinese Patent Application No. 202211548632.2, filed on Dec. 5, 2022, the entire contents of which are incorporated herein by reference.

### TECHNICAL FIELD

The present disclosure relates to the field of quality evaluation on point cloud maps, in particular to a method for evaluating quality of a point cloud map based on matching.

### BACKGROUND

A point cloud map, as one of the core technologies of automatic driving, can provide three-dimensional map information with centimeter precision for automatic driving. It provides important prior map information for perception, navigation, planning and decision-making modules and other modules in an unmanned technology. The point cloud map is usually established by fusing data of a plurality of sensors, including three-dimensional Lidar (light detection and ranging), a global positioning system (GPS) receiver, an inertial measurement unit (IMU) and one or more cameras. After the point cloud map is established according to the data of a plurality of sensors, the quality of the point cloud map has to be evaluated in order to ensure high precision of the established point cloud map.

The simplest method for evaluating the precision of the map drawn by the Lidar is to calculate errors between estimated positions and orientations and ground truths. However, the problem that the truths are not available always occurs in the process of drawing the point cloud map with high precision. Therefore, researchers have explored other quality evaluation methods, for example, the quality of the point cloud map is evaluated by evaluating the flatness of local ground in the point cloud map or evaluating the thicknesses of cylindrical surfaces of cylindrical objects in the point cloud map or other methods. These methods evaluate the quality of the point cloud map by extracting geometric features from the map. However, the accuracy of a geometric feature extraction algorithm is low, so artificial calibration is required in the process of evaluating the quality of the map by these methods, resulting in low efficiency.

Based on this, it is necessary to provide a full-automatic method for evaluating the quality of the point cloud map with low calculation complexity and without the dependence on the truth values and artificial calibration for the above technical problems, so as to rapidly and effectively evaluate the quality of the point cloud map.

### SUMMARY

The present disclosure aims at providing a method for evaluating quality of a point cloud map based on matching to solve the problems that truth values are difficult to acquire and geometric features are hardly extracted accurately in existing quality evaluation methods.

In order to realize the above objectives, the present disclosure provides a method for evaluating quality of a point cloud map based on matching, including the following steps:
S1, acquiring the to-be-evaluated point cloud map as a point cloud matching algorithm input;
S2, acquiring a point cloud sample set for matching;
S3, specific to each point cloud sample in the point cloud sample set, making the point cloud sample matched with the to-be-evaluated point cloud map by a point cloud matching algorithm, and obtaining an estimated three-dimensional coordinate system transform by iteration with the original three-dimensional coordinate system transform as an initial value;
S4, calculating point cloud matching errors; and
S5, calculating a quality evaluation score of the to-be-evaluated point cloud map as a point cloud matching algorithm output.

Preferably, acquiring the to-be-evaluated point cloud map includes the following steps: collecting point cloud data by a mobile mapping vehicle equipped with a plurality of sensors such as a GPS, an IMU and a mechanical rotary Lidar, moving along a road, then determining a coordinate system transform from each point cloud coordinate system to a navigation coordinate system by a mobile mapping or simultaneous localization and mapping (SLAM) algorithm, and finally transforming a series of point clouds to the navigation coordinate system by the coordinate system transforms and splicing them into a point cloud map, so that the to-be-evaluated point cloud map is established; and
the collected point cloud data includes but is not limited to a GPS positioning result, an IMU measurement result and a mechanical rotary Lidar scanning result, and data collected by other sensors such as an electronic compass, a wheel odometer and a barometer may also be added according to actual situations.

Preferably, the navigation coordinate system refers to a reference coordinate system used when navigation parameters are solved, and an East-North-Up (ENU) geographic coordinate system is usually adopted as the navigation coordinate system in actual application; and
the ENU geographic coordinate system refers to a rectangular coordinate system with a gravity center of a carrier as an origin and three coordinate axes sequentially pointing to three directions of east, north and up.

Preferably, methods for acquiring the point cloud sample set for matching include but are not limited to a method for field mapping or a method for sampling the to-be-evaluated point cloud map.

Preferably, each element in the point cloud sample set consists of a point cloud sample and an original three-dimensional coordinate system transform;
coordinate systems of the point cloud samples are Lidar coordinate systems, and the quantity of points of the point cloud samples is obviously less than that of points of the to-be-evaluated point cloud map; and
the Lidar coordinate systems refer to sensor coordinate systems where the point cloud data collected by Lidar is located.

Preferably, the algorithm for matching the point cloud samples with the to-be-evaluated point cloud map aims at calculating a coordinate system transform between two point clouds, such that the two point clouds can completely overlap with each other through the coordinate system transform, and the matching algorithm includes but is not limited to iterative closest point (ICP) and normal distributions transform (NDT).

Preferably, the original three-dimensional coordinate system transforms refer to known accurate transforms of the corresponding point cloud samples from the Lidar coordinate systems to the navigation coordinate system.

Preferably, the original three-dimensional coordinate system transforms briefly describe a transform relation between the Lidar coordinate systems where the point cloud samples are located and the navigation coordinate system.

Preferably, the estimated three-dimensional coordinate system transforms refer to transforms, estimated by the point cloud matching algorithm, of the point cloud samples from the Lidar coordinate systems to the navigation coordinate system.

Preferably, the point cloud matching algorithm input is two point clouds, and the point cloud matching algorithm output is an estimated transform relation between two point cloud coordinate systems, and
more specifically, the point cloud matching algorithm input is the point cloud samples and the to-be-evaluated point cloud map; and the point cloud matching algorithm output is an estimated transform relation between the Lidar coordinate systems where the point cloud samples are located and the navigation coordinate system.

Preferably, the point cloud matching errors are quantitatively-evaluated overlap degrees between the point cloud samples subjected to the estimated three-dimensional coordinate system transforms and the to-be-evaluated point cloud map.

Preferably, methods for calculating the point cloud matching errors include but are not limited to a method for measuring errors between the point cloud samples subjected to the estimated three-dimensional coordinate system transforms and the to-be-evaluated point cloud map by using mean square point matching errors, a sum of probabilities and other indexes.

Preferably, the quality evaluation score is obtained by calculating a mean of the point cloud matching errors corresponding to all the point cloud samples, and then normalizing the mean;
a method for calculating the quality evaluation score aims at giving different quality evaluation scores of the to-be-evaluated point cloud map for the point cloud matching errors obtained by different indexes; and
the larger the quality evaluation score, the higher the quality of the to-be-evaluated point cloud map, the higher the relative precision of local maps, and the smaller the ghosting degree of the local maps.

A method for extracting point cloud samples from a point cloud map by simulation includes the step: acquiring the point cloud samples in a simulation extraction manner according to an input transform relation between Lidar coordinate systems and the navigation coordinate system, the input point cloud map and point cloud sample structures actually obtained by mechanical rotary Lidar;

The method specifically includes the steps:
1), simulating a field mapping process, and performing simulation extraction at an equal interval in the to-be-evaluated point cloud map along a route where a mobile mapping vehicle collects data, so as to form a series of original three-dimensional coordinate system transforms;
2) establishing a Lidar coordinate system at each original three-dimensional coordinate system transform;
3) consulting a product manual according to a model of the to-be-simulated Lidar, to obtain corresponding product parameters;
4) obtaining an azimuth angle and a pitching angle of each point in the point cloud samples according to the product parameters; and
5) calculating a distance between each point and an origin of the corresponding Lidar coordinate system according to the azimuth angle and the pitching angle of each point in the point cloud samples, so as to form the point cloud samples.

Preferably, in the step of calculating the distance between each point and the origin of the corresponding Lidar coordinate system, the obtained distance can reflect a distance obtained by corresponding laser ranging in an actual map by simulation, and the following steps are specifically as follows:
a, obtaining a cone by taking a horizontal resolution angle and a vertical resolution angle of the to-be-simulated Lidar as field angles and the azimuth angle and the pitching angle where the to-be-solved point is located as a center;
b, intercepting all points out of the cone in the to-be-evaluated map;
c, performing spatial clustering on a set formed by all the intercepted points by a density-based spatial clustering of applications with noise (DBSCAN) algorithm;
d, projecting each point set obtained after clustering onto a plane perpendicular to azimuth rays of the azimuth angle and the pitching angle where the to-be-solved point is located;
e, performing solution to obtain a two-dimensional convex hull of the projection of each point set obtained by clustering;
f, screening out convex hulls not containing projection points of the rays from the two-dimensional convex hulls of all the point cloud projections;
g, obtaining a convex hull, closest to the origin of the Lidar coordinate system, of a gravity center of a corresponding three-dimensional point set from the rest of convex hulls by calculation; and
h, calculating a distance between a gravity center of a point set and the origin of the Lidar coordinate system in a ray direction as a final simulation extraction point distance according to the three-dimensional point set corresponding to the unique selected convex hull.

Disclosed is application of a method for extracting point cloud samples from a point cloud map by simulation in acquiring a point cloud sample set.

Thus, the method for evaluating the quality of the point cloud map based on matching provided by the present disclosure has the following technical effects:
1. The method for evaluating the quality of the point cloud map based on matching, includes the following steps: acquiring the to-be-evaluated point cloud map, acquiring the accurate point cloud samples for detection; specific to each element in the accurate point cloud samples for detection, matching accurate point clouds with the to-be-evaluated point cloud map by the matching algorithm, to obtain estimated three-dimensional point cloud transforms; calculating point cloud matching errors; and obtaining a quality evaluation score of the whole point cloud map according to the point cloud matching error obtained by each element in the accurate point cloud samples for detection;
2. the method for evaluating the quality of the point cloud map based on matching can simulate the process of positioning by using the point cloud map and reflect the quality of mapping from the final positioning effect of the map; and
3. the method for evaluating the quality of the point cloud map based on matching avoids the problem that a traditional method for evaluating the quality of the map based on track truth values cannot obtain the truth values, and meanwhile has lower calculation complexity compared with a method for evaluating the quality of the map based on geometric features.

The technical solutions of the present disclosure will be further described below in detail with reference to drawings and embodiments

### BRIEF DESCRIPTION OF THE DRAWINGS

In order to more clearly explain the technical solutions of embodiments of the present disclosure, drawings required to be used in the description of the embodiments will be briefly described below. Apparently, the drawings in the following description are only some embodiments of the present disclosure, according to which, those ordinarily skilled in the art can also obtain other drawings without inventive labor.

FIG. 1 is a schematic flow diagram of a method for evaluating quality of a point cloud map;

FIG. 2 is a schematic diagram of generation of an initial three-dimensional coordinate system transform by a point cloud matching algorithm;

FIG. 3 is a schematic flow diagram of a method for evaluating quality of a point cloud map;

FIG. 4 is a schematic diagram of a cone selected in a simulation extraction method;

FIG. 5 is a schematic diagram of projection of a three-dimensional point set onto a specific plane in a simulation extraction method, and

FIG. 6 is a schematic diagram of a two-dimensional convex hull of a projection point in a simulation extraction method.

### DETAILED DESCRIPTION OF THE EMBODIMENTS

The technical solutions of the present disclosure will be further explained with reference to drawings and embodiments.

To make the objectives, technical solutions, and advantages of the embodiments of the present application clearer, the technical solutions in two embodiments of the present disclosure will be clearly and completely described below with reference to the drawings and the embodiments.

In order to more clearly illustrate the technical solutions of the embodiments, firstly, definitions of common coordinate systems are given, including a navigation coordinate system, a geographic coordinate system, a Lidar coordinate system and the like, and part of three-dimensional coordinate system transforms include an original three-dimensional coordinate system transform, an estimated three-dimensional coordinate system transform, an initial three-dimensional coordinate system transform and the like.

The navigation coordinate system refers to a reference coordinate system used when navigation parameters are solved, and an East-North-Up (ENU) geographic coordinate system is usually adopted as the navigation coordinate system in actual application. The ENU geographic coordinate system refers to a rectangular coordinate system with a gravity center of a carrier as an origin and three coordinate axes sequentially pointing to three directions of east, north and up. The Lidar coordinate system refers to a sensor coordinate system where point cloud data collected by Lidar is located.

The three-dimensional coordinate system transforms describe how to transform among different coordinate systems. One three-dimensional coordinate system transform needs to simultaneously describe a translation amount and a rotation amount. Wherein, the original three-dimensional coordinate system transform refers to a known accurate transform from the Lidar coordinate system to the navigation coordinate system. The estimated three-dimensional coordinate system transform refers to a transform, estimated by a point cloud matching algorithm, of point cloud samples from the Lidar coordinate system to the navigation coordinate system. The initial three-dimensional coordinate system transform refers to an initial value of a coordinate system transform required by the point cloud matching algorithm.

In addition, it is also necessary to define a transform of point clouds in a three-dimensional space. The transform includes translation and rotation, wherein translation is described by a three-dimensional vector \vec{t}=[tₓ t_{y} t_{z}]^{T}, and rotation is described by both a rotation unit vector \vec{r}=[rₓ r_{y} r_{z}]^{T} and a rotation angle ϕ. It should be noted that there are only three freedom degrees in three-dimensional rotation, however, in order to facilitate the description, the three-dimensional rotation is described by four selected parameters: the rotation unit vector and the rotation angle herein. In addition, a quaternion \vec{q} is also usually used for describing rotation in a three-dimensional space, a relation among the quaternion, the rotation vector \vec{r}, and ϕ is q=cos ϕ+(rₓ cos ϕ)i+(r_{y} cos ϕ)j+(r_{z} cos ϕ)k, and a formula of a transform T on a point \vec{x} according to a three-dimensional coordinate system transform parameter

$${p}^{′′′} = {[ \begin{matrix}{{t}^{T}}^{′′′} & {{r}^{T}}^{′′′} & ϕ\end{matrix} ]}^{T}$$

is given.

$$T ( {p}^{′′′} , {x}^{′′′} ) = [ \begin{matrix}{er}_{x}^{2} + c & {er}_{x} {r}_{y} - {sr}_{z} & {er}_{x} {r}_{z} + {sr}_{y} \\ {er}_{x} {r}_{y} + {sr}_{z} & {er}_{y}^{2} + c & {er}_{y} {r}_{z} - {sr}_{x} \\ {er}_{x} {r}_{z} - {sr}_{y} & {er}_{y} {r}_{z} + {sr}_{x} & {er}_{z}^{2} + c\end{matrix} ] {x}^{′′′} + [ \begin{matrix}{t}_{x} \\ {t}_{y} \\ {t}_{z}\end{matrix} ]$$

Where, e=1|cos ϕ, c=cos ϕ, s=sin ϕ

As for the quality evaluation of a point cloud map, it is ensured to provide an accurate and reliable three-dimensional map for automatic driving by determining obtaining whether positions and orientations corresponding to point clouds in the point-cloud map are accurate, or whether the point cloud map is clear through analysis and calculation.

The implementation of specific steps in the content of the present disclosure is not limited to a certain method. The two embodiments hereafter merely describe two possible complete implementation methods, and algorithms used in each step may be substituted to some extent specifically.

Specific to step S1 of establishing the point cloud map, either a traditional mobile mapping method or a SLAM method based on multi-sensor fusion may be used, both of which can be used for acquiring the point cloud map according to collected data. The mobile mapping method has relatively high requirements on properties of adopted sensors, while the SLAM method based on multi-sensor fusion has low requirements on the properties of the sensors, however, it requires a plurality of types of sensors.

Specific to step S2 of acquiring a point cloud sample set for matching, either a field measurement method or a simulation extraction method may be used, both of which can be used for acquiring the point cloud sample set. A map collection device, is required for the field mapping method, but not for the simulation extraction method, to perform field collection. However, its accuracy is relatively low.

Specific to the point cloud matching algorithm in step S3, either an ICP algorithm or an NDT algorithm may be used, both of which can realize point cloud matching The ICP algorithm is higher in complexity and better in translation robustness, while the NDT algorithm is relatively lower in complexity and better in rotation robustness.

Specific to step S4 of calculating point cloud matching errors, either mean square point matching errors in the ICP algorithm or a sum of probabilities in the NDT algorithm may be used as measures, both of which can measure the point cloud matching errors Even if the ICP algorithm is used, the sum of probabilities may still be used as the measure of the point cloud matching errors. Even if the NDT algorithm is used, the mean square point matching errors may still be used as the measure of the point cloud matching errors. Both algorithms may not be limited to the matching algorithm in step 3.

Step S5 of calculating a quality evaluation score depends on the selection of the point cloud matching errors in step 4. The quality evaluation scores calculated according to different types of point cloud matching errors are not comparable. For example, the quality evaluation score obtained according to the mean square point matching errors by calculation cannot be compared with the quality evaluation score obtained according to the sum of probabilities by calculation. However, different matching algorithms may be used in step 3, the same type of point cloud matching errors may be used in step 4, and the same type of quality evaluation scores may be calculated in step 5.

Embodiment 1 A to-be-evaluated point cloud map is acquired as an algorithm input by a mobile mapping method for evaluating quality of the point cloud map

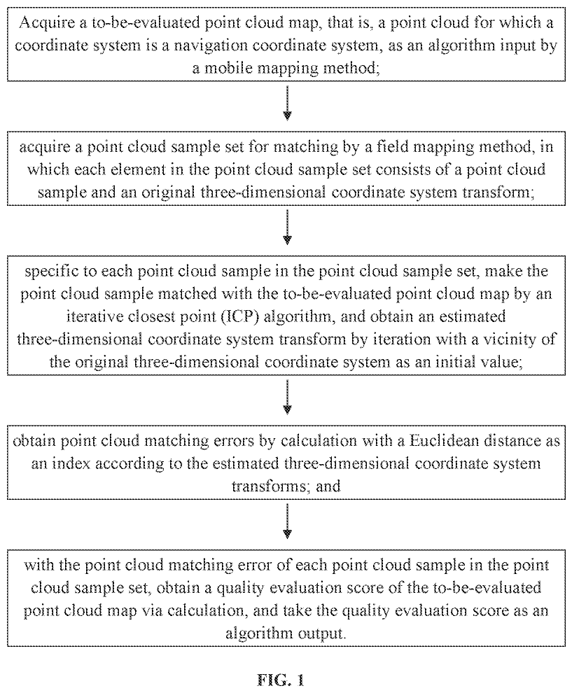

A method for evaluating quality of a point cloud map based on matching, as shown in FIG. 1, includes the following steps:
S1, the to-be-evaluated point cloud map is acquired as an algorithm input by a mobile mapping method, wherein the to-be-evaluated point cloud map is a point cloud for which a coordinate system is a navigation coordinate system;
S2, a point cloud sample set for matching is acquired by a field mapping method, wherein each element in the point cloud sample set consists of a point cloud sample and an original three-dimensional coordinate system transform;
S3, specific to each point cloud sample in the point cloud sample set, the point cloud sample is matched with the to-be-evaluated point cloud map by an ICP algorithm, and an estimated three-dimensional coordinate system transform is obtained by iteration with a vicinity of the original three-dimensional coordinate system as an initial value;
S4, point cloud matching errors are obtained by calculation with a Euclidean distance as an index according to the estimated three-dimensional coordinate system transforms; and
S5, a quality evaluation score of the to-be-evaluated point cloud map is obtained according to the point cloud matching error of each point cloud sample in the point cloud sample set, and the quality evaluation score is taken as an algorithm output.

More specifically, according to the mobile mapping method in step S1, a mobile mapping vehicle equipped with a GPS, an IMU and a mechanical rotary Lidar moves along a road to collect surrounding environment information and constantly record position information. After all the data is collected, a high-precision integrated navigation system formed by the GPS and the IMU is usually used to output high-frequency (usually the same as output frequency of the IMU) orientation, position and speed information of a carrier, and a coordinate system transform from point cloud coordinate systems at different moments to the navigation coordinate system can be obtained after processing. The surrounding environment information is collected by the Lidar, however, reference coordinate systems of the data collected at different motion moments of the Lidar are different as the Lidar is based on spin imaging when collecting the surrounding environment information. In order to establish the final point cloud map, motion compensation is necessary, thus, the high-frequency information output by the integrated navigation system needs to be subjected to linear interpolation, laser point clouds collected by the Lidar making a full rotation are transformed to the point cloud coordinate system at the same moment, so as to obtain a series of point clouds, finally, the series of point clouds are transformed to the navigation coordinate system by the coordinate system transforms obtained after integrated navigation, followed by being spliced into one point cloud map.

More specifically, step S2 of acquiring the accurate point cloud samples by field mapping specifically includes the steps that the mobile mapping vehicle equipped with the GPS, the IMU and the mechanical rotary Lidar collects the position and orientation and the surrounding environment of the carrier in a static state in the same mapping scenario. The position and orientation of the carrier are obtained according to the GPS and the IMU, and the coordinate system transform, namely the original three-dimensional coordinate system transform, from the point cloud coordinate system at a current static position to the navigation coordinate system can be obtained after processing. Motion compensation is not needed as the Lidar is static, and laser points collected by the Lidar making a full rotation are directly used as the point cloud samples. Finally, in order to more comprehensively evaluate the quality of the whole map, appropriate sampling has to be performed within the range of the whole map, and therefore field data collection at an equal interval is performed along a data collection route of the mobile mapping vehicle in step S1. Wherein, the interval space is 5 m.

More specifically, the ICP algorithm in step S3 is a common matching algorithm in three-dimensional point cloud registration, the estimated three-dimensional coordinate system transforms can be obtained by iterative calculation with the vicinities of the original three-dimensional coordinate system transforms as the initial values, and finally the distance between the two transformed point clouds is the smallest. In each iteration, specific to each point in the target point cloud, the algorithm will search for a point closest to the above point in the reference point cloud, calculates three-dimensional coordinate system transform parameters \vec{p} according to these paired points, and performs three-dimensional coordinate system transforms on the target point cloud, so as to obtain a new target point cloud and get into a next iteration process till expected requirements are met. Finally, an excellent transform matrix can be obtained, so as to achieve precise registration between the two point clouds.

The specific algorithm of the ICP is as follows:
1) the target point cloud X={\vec{x}ᵢ} containing N_{X} points and the reference point cloud Y containing N_{Y} points are known, and the estimated three-dimensional coordinate system transform is required, such that the target point cloud X subjected to the estimated three-dimensional coordinate system transform and the reference point cloud Y are precisely registered;
2) specific to each point \vec{x}ᵢ in the target point cloud, the reference point cloud Y is searched for a point \vec{y}ᵢ, so that an Euclidean distance between the point \vec{y}ᵢ and the point \vec{x}ᵢ is the minimum, that is,

$$d ( {\vec{x}}_{i} , Y ) = {min}_{{\vec{y}}_{k} ∈ Y} ‖ {\vec{y}}_{k} - {\vec{x}}_{i} ‖ = ‖ {\vec{y}}_{i} - {\vec{x}}_{i} ‖ ,$$

wherein a new point cloud Z={\vec{z}ᵢ|\vec{z}ᵢ=\vec{y}ₖ} is formed by all \vec{y}ₖ, and the point cloud Z contains N_{X} points;
3) a gravity center

$${\vec{μ}}_{X} = \frac{1}{{N}_{X}} {\sum }_{i = 1}^{{N}_{X}} {\vec{x}}_{i}$$

of a point set X and a gravity center

$${\vec{μ}}_{Z} = \frac{1}{{N}_{p}} {\sum }_{i = 1}^{{N}_{P}} {\vec{z}}_{i}$$

of a point set Z are calculated;
4) a covariance matrix

$${\sum }_{XZ} = \frac{1}{{N}_{X}} {\sum }_{i = 1}^{{N}_{X}} [ ( {\vec{x}}_{i} - {\vec{μ}}_{X} ) {( {\vec{z}}_{i} - {\vec{μ}}_{Z} )}^{T} ] = \frac{1}{{N}_{X}} {\sum }_{i = 1}^{{N}_{X}} [ {\vec{x}}_{i} {\vec{z}}_{i}^{T} ] - {\vec{μ}}_{X} {\vec{μ}}_{Z}^{T}$$

between the point set X and the point set Z is calculated;
5) an antisymmetric matrix A=Σ_{XZ}−Σ_{XZ}^{T} is generated according to the covariance matrix Σ_{XZ}, a column vector Δ=[A₂₃ A₃₁ A₁₂]^{T} is further obtained, a symmetric matrix

$$Q ( {\sum }_{XZ} ) = {[ \begin{matrix}tr ( {\sum }_{XZ} ) & {Δ}^{T} \\ Δ & {\sum }_{XZ} + {\sum }_{XZ}^{T} - tr ( {\sum }_{XZ} ) {I}_{3}\end{matrix} ]}_{4 \times 4}$$

is finally generated, and a rotation quaternion \vec{q}=q₀+q₁\vec{l}+q₂\vec{j}+q₃\vec{k} can be obtained according to a feature vector [q₀ q₁ q₂ q₃]^{T} corresponding to a maximum feature value of the symmetric matrix Q(Σ_{XZ});
6) a corresponding rotation matrix

$$R ( \vec{q} ) = [ \begin{matrix}{q}_{0}^{2} + {q}_{1}^{2} - {q}_{2}^{2} - {q}_{3}^{2} & 2 ( {q}_{1} {q}_{2} - {q}_{0} {q}_{3} ) & 2 ( {q}_{1} {q}_{3} + {q}_{0} {q}_{2} ) \\ 2 ( {q}_{1} {q}_{2} + {q}_{0} {q}_{3} ) & {q}_{0}^{2} + {q}_{2}^{2} - {q}_{1}^{2} - {q}_{3}^{2} & 2 ( {q}_{2} {q}_{3} - {q}_{0} {q}_{1} ) \\ 2 ( {q}_{1} {q}_{3} - {q}_{0} {q}_{2} ) & 2 ( {q}_{2} {q}_{3} + {q}_{0} {q}_{1} ) & {q}_{0}^{2} + {q}_{3}^{2} - {q}_{1}^{2} - {q}_{2}^{2}\end{matrix} ]$$

can be generated according to the rotation quaternion;
7) then a corresponding translation amount \vec{t}=\vec{μ}_{Z}R(\vec{q})\vec{μ}_{X} is obtained by calculation;
8) rotation and translation changes resulting therefrom are applied to the target point cloud X, Xₖ₊₁=R(\vec{q})Xₖ+\vec{t};
9) a mean square point matching error

$${d}_{k + 1} = {min}_{{\vec{x}}_{i} ∈ {X}_{k + 1}} d ( {\vec{x}}_{i} , Y )$$

between Xₖ₊₁ and Y is calculated; and
10) it is determined whether an iteration ending condition is met, if dₖ₊₁−dₖ<Σ, the iteration ending condition is met, it exits a loop, or else it skips to perform step 2.

The above describes the algorithm flow of the ICP. As the ICP is a simple iterative convergence process, the finally obtained transform is not correct for the reason that a local optimum is easily converged, and it is usually necessary to provide an initial value of a good three-dimensional coordinate system transform for the ICP, such that convergence to the vicinity of a correct position and orientation transform can be achieved finally via ICP. Usually, the initial value of the position and orientation transform is determined according to IMU dead reckoning or obtained by applying tiny offset to the original three-dimensional coordinate system transform. In consideration of the situation that acceleration and angular speed information not including an IMU output is input during quality evaluation of the point cloud, the ICP initial value can be obtained only by applying the tiny offset to the original three-dimensional coordinate system transform herein.

In addition, as the ICP needs to calculate a closest point cloud from each point in the target point cloud X to the reference point cloud Y, the calculation complexity is O(N_{X}N_{Y}), and the calculation amount is extremely large. Therefore, it is necessary to reduce the quantity of points of the target point cloud X and the reference point cloud Y, and thus the quantity of the point clouds is usually reduced by selecting a downsampling or local point cloud interception method. In order to improve the quality of the evaluated to-be-evaluated point cloud, it is necessary to separate out errors caused by the influence of other factors as much as possible in the method for evaluating the quality of the point clouds. In order not to introduce additional errors, only selection of local point cloud interception on the target point cloud X and the reference point cloud Y is effective, so as to reduce the quantity of the points.

More specifically, detailed steps of step S3 are as follows:

Firstly, the to-be-evaluated point cloud map is subjected to local map interception, as the original three-dimensional coordinate system transform of the point cloud sample relative to the navigation coordinate system is known, a sphere is drawn by selecting a corresponding position of a translation amount of the original three-dimensional coordinate system transform as a center of the sphere and a radius as 25 m, all points in the sphere are intercepted out, and a local to-be-evaluated point cloud map is obtained. Then it is necessary to locally intercept the point cloud samples, a sphere is drawn by selecting an origin as a center of the sphere and a radius of 25 m in the same way, all points in the sphere are intercepted out, and local point cloud samples are obtained.

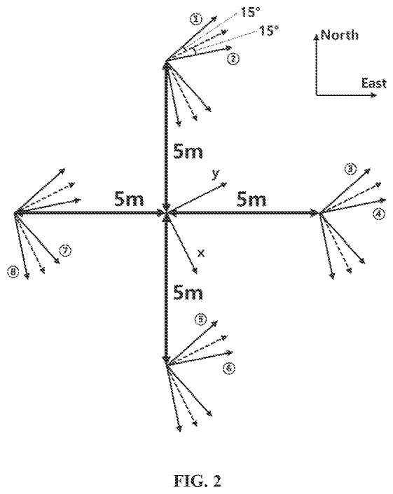

In addition, it is also necessary to provide a good initial three-dimensional coordinate system transform for the ICP algorithm. In order to reduce the influence of the original three-dimensional coordinate system transform on a final matching result as much as possible, the same point cloud sample is subjected to a plurality of times of matching alignment by using different initial three-dimensional coordinate system transforms, and finally a mean of a plurality of estimated coordinate system transforms is taken as an estimated three-dimensional coordinate system transform. In consideration that the point clouds are mostly collected by the vehicle, eight initial three-dimensional coordinate system transforms are obtained in total by applying translation offset in a horizontal direction and rotation offset in an up direction to the original three-dimensional coordinate system transform, specifically as shown in FIG. 2. Positions of the eight initial three-dimensional coordinate system transforms in the figure are made to be distributed at positions 5 m deviating from four directions of cast, south, west and north of the original three-dimensional coordinate system transform, and there are two initial three-dimensional coordinate system transforms at each position, which are positive rotation by 15 degrees and negative rotation by 15 degrees in the up direction.

Then, after the point cloud sample is subjected to the eight initial three-dimensional coordinate system transforms, it is matched with the local to-be-evaluated point cloud map by the ICP. Wherein, the point cloud sample is the target point cloud X in the ICP algorithm, and the local to-be-evaluated point cloud map is the reference point cloud Y in the ICP algorithm.

More specifically, in step S4, the point cloud matching error, namely a matched mean square error dₖ₊₁ in the ICP algorithm, is obtained by calculation with the Euclidean distance as the index, and thus, finally, the ICP matched mean square errors obtained by transformation over the eight initial three-dimensional coordinate system transforms are averaged, to obtain the point cloud matching error. More specifically, the point cloud matching error obtained in step S4 describes a minimum value of a distance between each point of the point cloud sample and each point of the to-be-evaluated point cloud map nearby it. The larger the minimum value, the larger the offset of the local of the to-be-evaluated point cloud map from the local of the actual map. Thus, it can be shown that the point cloud matching error obtained in step S4 essentially describes local quality evaluation scores of the to-be-evaluated point cloud map.

More specifically, in step S5 of calculating the quality evaluation score of the to-be-evaluated point cloud map, the final quality evaluation score can be obtained only by normalizing the mean point cloud matching error d_{ICP}_{_{--TOTAL}} of the whole map. In consideration that the point cloud map is finally applied to precise positioning, a positioning evaluation index of 0.1 m commonly used in the field of automatic driving is selected as a normalization factor herein, to obtain the final quality evaluation score, namely

$$QA = \frac{0.1 m}{{d}_{{ICP}_{- TOTAL}}} .$$

### Where,

$${d}_{{ICP}_{{}_{TOTAL}}} = \frac{1}{{N}_{p}} {\sum }_{i = 1}^{{N}_{p}} {d}_{i} ,$$

and dᵢ is the point cloud matching error between each point cloud sample and the to-be-evaluated point cloud map. According to a calculation formula, the smaller the point cloud matching error, the larger the quality evaluation score, and the higher the quality of the map.

Embodiment 2 A to-be-evaluated point cloud map is obtained by a SLAM method based on multi-sensor fusion as an algorithm input for evaluating quality of the point cloud map

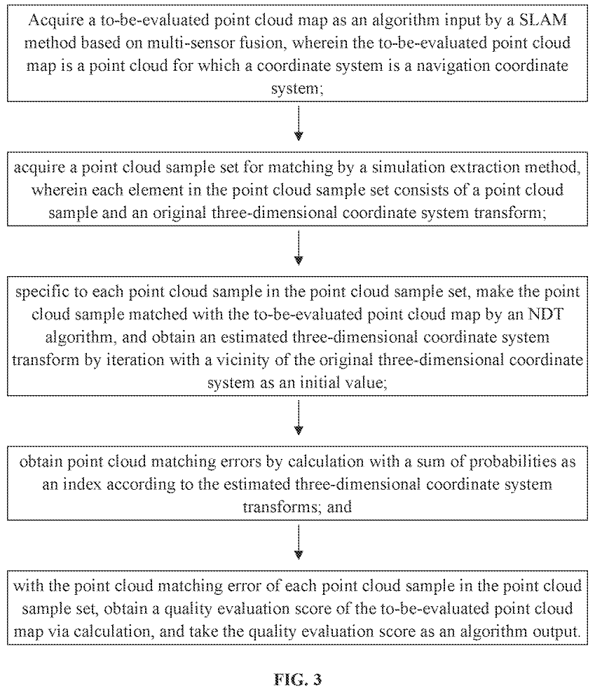

A method for evaluating quality of a point cloud map based on matching, as shown in FIG. 3, includes the steps:
1, the to-be-evaluated point cloud map is acquired as an algorithm input by a SLAM method based on multi-sensor fusion, wherein the to-be-evaluated point cloud map is a point cloud for which a coordinate system is a navigation coordinate system;
2, a point cloud sample set for matching is acquired by a simulation extraction method, wherein each element in the point cloud sample set consists of a point cloud sample and an original three-dimensional coordinate system transform;
3, specific to each point cloud sample in the point cloud sample set, the point cloud sample is matched with the to-be-evaluated point cloud map by an NDT algorithm, and an estimated three-dimensional coordinate system transform is obtained by iteration with a vicinity of the original three-dimensional coordinate system as an initial value;
4, point cloud matching errors are obtained by calculation with a sum of probabilities as an index according to the estimated three-dimensional coordinate system transforms, and
5, a quality evaluation score of the to-be-evaluated point cloud map is obtained according to the point cloud matching error of each point cloud sample in the point cloud sample set, and the quality evaluation score is taken as an algorithm output.

Specifically, in the SLAM method based on multi-sensor fusion in step 1, usually a mobile mapping vehicle equipped with a GPS, an IMU, a mechanical rotary Lidar and other various sensors (including but not limited to an electronic compass, a wheel odometer, a barometer and the like) moves along a road to collect surrounding environment information and constantly record position and orientation information. After all the data is collected, the following processing needs to be performed: firstly, point cloud data collected by the Lidar is subjected to motion compensation by using high-frequency acceleration and angular speed data output by the IMU, then point clouds obtained after motion compensation are subjected to interframe matching, to obtain a position and orientation transform between two frames of point clouds between two pieces of adjacent time, front-end fusion of SLAM is achieved by IMU fusion, then multi-sensor fusion is achieved by additionally arranging the GPS and other sensors at a rear end of the SLAM, and a final point cloud map is obtained.

More specifically, obtaining the point cloud samples by simulation extraction in step 2 means that field mapping is not performed, or conditions for performing field mapping again are not available. Part of point clouds are extracted from the to-be-evaluated point cloud map by simulation as the point cloud samples. The simulation extraction means that field data collection is simulated, part of sampling points is selected from the to-be-evaluated point cloud map, a surrounding environment is scanned by simulation with the sampling points as initial points of Lidar coordinate systems, and a frame of point cloud samples is generated. The original three-dimensional coordinate system transform is a transform from a current Lidar coordinate system to the navigation coordinate system. In order to acquire the point cloud samples in a simulation extraction manner, structures of laser point clouds obtained in field collection have to be defined.

A working principle of the mechanical rotary Lidar is as follows: a plurality of laser rangefinders are vertically arranged (the quantity of the laser rangefinders is usually 16, 32, 64 and even 128) at a certain included angle, and then installed on a support rotating around its own axis. The support rotates by a circle to drive the plurality of laser rangefinders to rotate by a circle, the laser rangefinders simultaneously measure to obtain a distance of the surrounding environment, to form point cloud samples, and each point in the formed point cloud samples is obtained by measuring, by a certain laser range finder, the distance in a certain direction. Thus, during simulation of the field data, horizontal angle ranges, horizontal resolution angles, vertical angle ranges and vertical resolution angles in the point clouds have to be known. There are 16 laser rangefinders in VLP-16 Lidar from Velodyne, and parameters of the VLP-16 Lidar are shown in Table 1.

TABLE 1

| Name | Value/° |
|---|---|
| Horizontal angle range | 0~360 |
| Horizontal resolution angle | 0.2 (600 rpm) |
| Vertical angle range | −15~+15 |
| Vertical resolution angle | 2 |

Angle distribution of all the points in the point cloud samples can be obtained according to the parameters of the Lidar. Then the field mapping process can be simulated, and the point clouds are extracted from the to-be-evaluated point cloud map to form the point cloud samples. Similar to Embodiment 1, simulation extraction at an equal interval (5 m) is performed along the data collection route of the mobile mapping vehicle in step 1, so as to form a series of original three-dimensional coordinate system transforms. A Lidar coordinate system is established at each original three-dimensional coordinate system transform, finally the distance of each point is calculated according to the angle distribution of each point in the point cloud samples, thereby forming the point cloud samples.

Wherein, the key to simulation extraction is to calculate the distance of each point according to the angle distribution of each point in the point cloud samples. For the sake of clarity, the following description is made, a to-be-solved point is A, a horizontal resolution is r_{H}, a vertical resolution is r_{V}, an azimuth angle where the to-be-solved point A is located is α, a pitching angle where the to-be-solved point A is located is ω, an origin of a Lidar coordinate system is O, and rays from the origin O of the Lidar coordinate system to the to-be-solved point A are l_{OA}.

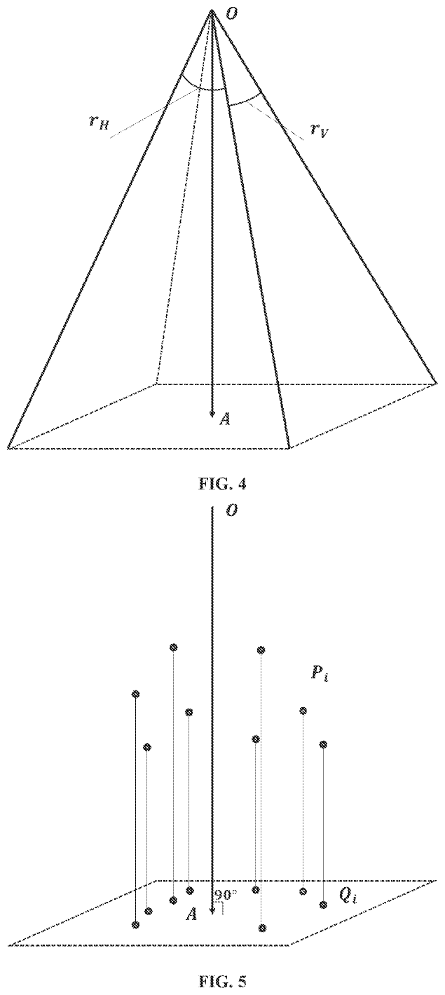

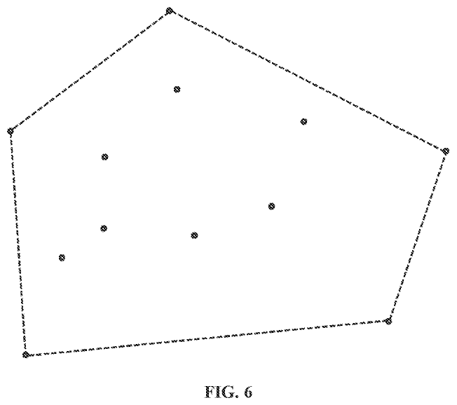

Calculating the distance between each to-be-solved point and the origin of the Lidar coordinate system specifically includes the following steps:
a, a cone is obtained by taking the horizontal resolution angle r_{H} and the vertical resolution angle r_{V} of the to-be-simulated Lidar as horizontal and vertical field angles and the rays l_{OA} from the origin O of the Lidar coordinate system to the to-be-solved point A as a central axis, specifically as shown in FIG. 4;
b, all points in the cone in the to-be-evaluated map are intercepted out, and a point set intercepted out of the to-be-evaluated map is denoted as P;
c, spatial clustering is performed on the set P formed by all the intercepted points by a DBSCAN algorithm;
d, each point set Pᵢ obtained after clustering is projected onto a plane perpendicular to l_{OA}, specifically as shown in FIG. 5;
e, a three-dimensional convex hull of a projection Qᵢ of each point set Pᵢ obtained after clustering is solved, specifically as shown in FIG. 6;
f, convex hulls not containing projection points of the rays are screened out of the two-dimensional convex hulls of all the point cloud projections Qᵢ;
g, a distance dᵢ between a gravity center of a three-dimensional point set Pᵢ corresponding to each convex hull and the origin O of the Lidar coordinate system in a direction of the rays l_{OA} is calculated from the rest of convex hulls; and
h, a minimum distance min dᵢ is screened out as a final simulation extraction point distance.

The DBSCAN algorithm is used when the distance between each to-be-solved obtained and the origin of the Lidar coordinate system is calculated. According to the DBSCAN, different clusters are distinguished by using density connectivity, densities in the same cluster are mutually connected, however, densities in different clusters cannot be connected. In order to further describe the DBSCAN, relevant definitions relevant to density connectivity need to be given:
Definition 1. Eps neighborhood: specific to an Eps neighborhood N_{Eps}(p) [symbol] {q∈D|dist(p,q)<Eps} of a point p in a set D;
Definition 2. Directly density-reachable: if p∈N_{Eps}(q) and |N_{Eps}(q)|≥MinPts (that is, the quantity of points of N_{Eps}(q) is greater than that of MinPts), it is called directly density-reachable from q to p;
Definition 3. Density-reachable: if a chain p₁, . . . , pₙ, p₁=q, pₙ=q exists between p and q and directly density-reachable is available from pᵢ to pᵢ₊₁, it is called directly density-reachable from q to p;
Definition 4. Density connectivity: if o exists, density-reachable from o to p and density-reachable from o to q are made to be realized, it is called density connectivity between p and q;
Definition 5. Cluster: specific to the data set D, a cluster C is a non-empty set, and meets the following conditions: 1) if ∀p∈C, q∈D and density-reachable is available from p to q, q∈C; and 2) if ∀p, q∈C, and density connectivity between p and q is realized.
Definition 6. Noise: specific to the data set D, if there are a plurality of clusters C₁, . . . , Cₖ, noise noist={p∈D|∀i: p∉Cᵢ}.

Part of pseudocodes of the DBSCAN are as follows:

Input: D is the data set containing n sample points; Eps is a radius; and MinPts is the minimum quantity of sample points; and

Output: cluster set.
1) All the points in D are initialized and marked as not accessed;
2) all the points in D are traversed as of a non-accessed point p;
3) p is marked as accessed;
4) N is denoted as an Eps neighborhood of p;
5) if the quantity of points of N is greater than or equal to MinPts;
6) a new cluster C is established, and p is put into C;
7) all points q in N are traversed;
8) if q is not accessed;
9) q is marked as accessed;
10) M is denoted as an Eps neighborhood of q;
11) if the quantity of points of M is greater than or equal to MinPts, the points in M are put into N;
12) if q does not belong to any cluster, q is put into C;
13) or else, p is marked as noise; and
14) if all the points are accessed, the operation ends.

In the step of calculating the distance between each to-be-solved point and the origin of the Lidar coordinate system, a two-dimensional convex hull Graham algorithm is used to calculate the two-dimensional convex hulls of the projections Qᵢ of the three-dimensional point sets Pᵢ. The Graham algorithm is a simple and effective two-dimensional convex hull calculation method, and its key is polar angle sorting and direction judgment processes of nodes. Before describing the Graham algorithm, definitions of the convex hulls are given firstly.

Specific to a point set S={p₁, . . . , pₙ}, a convex hull is denoted as

$$conv ( S ) = \{ y \vert ∀ {λ}_{i} 〉 0 , {\sum }_{i = 1}^{n} {λ}_{i} = 1 , y = {\sum }_{i = 1}^{n} {λ}_{i} {p}_{i} , {p}_{i} ∈ S \} .$$

If the point set S⊆R², the convex hull is denoted as conv(S)⊆R². The Graham algorithm used herein is a two-dimensional convex hull algorithm, and pseudocodes of the Graham algorithm are as follows:

Input: point set S={p₁, . . . , pₙ}; and

Output: the boundary and the quantity of polar points of the convex hull conv(S) of the point set S.
1) A point at the lowest position in the point set S is found (if there are a plurality of points at the lowest position, the point at the rightmost end is selected), and denoted as P₀;
2) points in a set S-{P₀} are sorted from small to large according to forward included angles between connecting lines of the points and P₀ and an axis x (if the included angles are the same, the points are sorted from near to far), and sorting results are denoted as P₀, . . . , Pₙ₋₁;
3) P₀ is initialized, P₁ is stacked, i=2, and it gets into a loop;
4) if Pᵢ is strictly located on a right side of a P̅₀̅P̅^̅{̅t̅}̅ connecting line (P^{t} is a stack

top element);
5) P^{t} is unstacked;
6) it returns to step 4);
7) or else;
8) Pᵢ is stacked;
9) if Pᵢ≠Pₙ₋₁;
10) i=i+1;
11) it returns to step 4);
12) or else;
13) the loop ends, and elements in a stack are sequentially output.

More specifically, the NDT algorithm in step 3 is a common matching algorithm in three-dimensional point cloud registration, the reference point cloud may be represented by a plurality of grids described as a normal distribution, the sum of probabilities of all the points in the transformed target point cloud serves as a target function in an optimization problem, the target point cloud aligns at the needed transform to serve as a to-be-optimized variable, so as to establish the optimization challenge, and the optimization challenge is solved to obtain translation and rotation between the two point clouds, thereby finally realizing the maximum probability of overlap between the two transformed point clouds. Different from processing of the ICP for each point, the NDT algorithm is used to permit the solution with the normal distribution in each grid in a grid network, such that the calculation complexity is greatly reduced, and meanwhile as the NDT describes the overlap degree between the two point clouds based on the probability method, the robustness degree of the algorithm for local noise is obviously improved.

The specific algorithm of the NDT is as follows:
1) the target point cloud X={\vec{x}ᵢ} containing N_{X} points and the reference point cloud Y containing N_{Y} points are known, and the transform containing rotation and translation is required, such that the transformed target point cloud X and reference point cloud Y are precisely registered;
2) the reference point cloud Y is divided into the grid network, each grid is a cube with a side length of d_{grid}, and may contain a plurality of points in the reference point cloud Y. and the grids with the quantity of the points contained therein, which are less than Nₗₑₛₛ, are removed;
3) then all Nᵢ reference points \vec{y}ᵢⱼ in each grid bᵢ are found, and a mean vector

$${\vec{μ}}_{i} = \frac{1}{{N}_{i}} {\sum }_{j = 1}^{{N}_{i}} {\vec{y}}_{ij}$$

and an autocovariance matrix

$${\sum }_{i} = \frac{1}{{N}_{i}} {\sum }_{j = 1}^{{N}_{i}} [ ( {\vec{y}}_{ij} - {\vec{μ}}_{i} ) {( {\vec{y}}_{ij} - {\vec{μ}}_{i} )}^{T} ]$$

of each point in the grid are calculated, so that the grid bᵢ can be described by using a three-dimensional normal distribution, a probability density function of the normal distribution is

$$P ( \vec{x} ) = \frac{1}{{c}_{i}} exp ( - \frac{{( \vec{x} - {\vec{μ}}_{i} )}^{T} {\sum }_{i}^{- 1} ( \vec{x} - {\vec{μ}}_{i} )}{2} ) ,$$

where, cᵢ is a factor for normalizing the probability density function;
4) then an initial transform parameter \vec{p} is given, and it starts to get into an iterative loop;
5) specific to each point \vec{x}ᵢ in the target point cloud X, the grid bᵢ containing the point is found, T(\vec{p},\vec{x}ᵢ)−\vec{μ}ᵢ is calculated, and a probability

$$P ( T ( \vec{p} , {\vec{x}}_{i} ) ) = \frac{1}{c} exp ( - \frac{{\vec{x}}_{i}^{T} {\sum }_{i}^{- 1} {\vec{x}}_{i}}{2} )$$

corresponding to the point is calculated;
6) a score

$$score ( p ) = {\sum }_{i = 1}^{{N}_{X}} P ( T ( {p}^{′′′} , {{x}_{i}}^{′′′} ) )$$

about the transform parameter p can be obtained according to a sum of probabilities P(\vec{x}ᵢ) corresponding to all the points \vec{x}ᵢ in the target point cloud X;
7) then a gradient g and a hessian matrix H of the score are calculated according to the following formula;

$${g}_{i} = \frac{δ s}{δ {p}_{i}} = {\sum }_{k = 1}^{{N}_{X}} {x}_{k}^{′ T} {\sum }_{k}^{- 1} \frac{δ {x}_{k}^{′}}{δ {p}_{i}} exp ( - \frac{{x}_{k}^{′ T} {\sum }_{k}^{- 1} {x}_{k}^{′}}{2} ) \qquad ( 1 )$$

$${H}_{ij} = \frac{δ s}{δ {p}_{i} δ {p}_{j}} = {\sum }_{k = 1}^{n} exp ( - \frac{{\vec{x}}_{k}^{′ T} {\sum }_{k}^{- 1} {\vec{x}}_{k}^{′}}{2} ) ( ( {x}_{k}^{′ T} {\sum }_{k}^{- 1} \frac{δ {\vec{x}}_{k}^{′}}{{δ}_{{p}_{i}}} ) \times ( - {x}_{k}^{′ T} {\sum }_{k}^{- 1} \frac{δ {\vec{x}}_{k}^{′}}{δ {p}_{j}} ) + {x}_{k}^{′ T} {\sum }_{k}^{- 1} \frac{{δ}^{2} {x}_{k}^{′}}{δ {p}_{i} δ {p}_{j}} + \frac{δ {x}_{k}^{′ T}}{δ {p}_{j}} {\sum }_{k}^{- 1} \frac{δ {\vec{x}}_{k}^{′}}{δ {p}_{i}} ) \qquad ( 2 )$$

where,

$$\frac{δ {x}_{k}^{′}}{δ {p}_{i}}$$

is an ith column of J₇, and

$$\frac{{δ}^{2} {x}_{k}^{′}}{δ {p}_{i} δ {p}_{j}} = {H}_{xij} ;$$

$${J}_{7} = {[ \begin{matrix}1 & 0 & 0 \\ 0 & 1 & 0 \\ 0 & 0 & 1 \\ e ( 2 {r}_{x} {x}_{1} + {r}_{y} {x}_{2} + {r}_{z} {x}_{3} ) & {er}_{y} {x}_{1} - {sx}_{3} & {er}_{2} {x}_{1} + {sx}_{2} \\ {er}_{x} {x}_{2} + {sx}_{3} & e ( {r}_{x} {x}_{1} + 2 {r}_{y} {x}_{2} + {r}_{z} {x}_{3} ) & {er}_{z} {x}_{2} - {sx}_{1} \\ {er}_{x} {x}_{3} - {sx}_{2} & {er}_{y} {x}_{3} + {sx}_{1} & e ( {r}_{x} {x}_{1} + {r}_{y} {x}_{2} + 2 {r}_{z} {x}_{3} ) \\ sA - cB & sC - cD & sE - cF\end{matrix} ]}^{T}$$

where, A=(rₓ²−1)x₁+rₓr_{y}x₂+rₓr_{z}x₃, B=r_{z}x₂−r_{y}x₃, C=rₓr_{y}x₁+(r_{y}²−1)x₂+r_{y}r_{z}x₃, D=−r_{z}x₁+rₓx₃, E=rₓr_{z}x₁+r_{y}r_{z}x₂+(r_{z}²−1)x₃, F=r_{y}x₁−rₓx₂,

$${H}_{x} = [ \begin{matrix}0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & a & b & c & d \\ 0 & 0 & 0 & b & e & f & f \\ 0 & 0 & 0 & c & f & h & i \\ 0 & 0 & 0 & d & g & i & j\end{matrix} ]$$

where, a=[2ex₁ 0 0]^{T},

b=[ex₂ ex₁ 0]^{T},

c=[ex₃ 0 ex₁]^{T},

d=[s(2rₓx₁+r_{y}x₂+r_{z}x₃) sr_{y}x₁−cx₃ sr_{z}x₁+cx₂]^{T},

e=[0 2ex₂ 0]^{T},

f=[0 ex₃ ex₂]^{T},

g=[srₓx₂+cx₃ s(rₓx₁+2r_{y}x₂+r_{z}x₃) sr_{z}x₂−cx₁]^{T},

h=[0 0 2ex₃]^{T},

i=[srₓx₃−cx₂ sr_{y}x₃+cx₁ s(rₓx₁+r_{y}x₂+2r_{z}x₃)]^{T},

j=[cA+sB cC+sD cE+sF]^{T};
8) HΔp=−g is solved, and p=p+Δp is updated; and
9) it is determined whether a convergence condition is met, and if yes, it exits a loop, and the NDT is completed.

The above describes the algorithm flow of the NDT. As the NDT is a simple iterative convergence process, the finally obtained transform is not correct for the reason that a local optimum is easily converged, it is usually necessary to provide an initial value of the good three-dimensional coordinate system transform for the NDT, such that convergence to the vicinity of a correct position and orientation transform can be achieved finally via ICP. Usually, the initial value of the position and orientation transform is determined according to IMU dead reckoning or obtained by applying tiny offset to the original three-dimensional coordinate system transform. In consideration of the situation that acceleration and angular speed information not including an IMU output is input during quality evaluation of the point cloud, the NDT initial value can be obtained only by applying the tiny offset to the original three-dimensional coordinate system transform herein.

Although the calculation amount of the NDT is obviously reduced compared with the ICP, in order to keep the consistency of input point clouds with the ICP matching algorithm, it is still necessary to reduce the quantity of the points of the target point cloud X and the reference point cloud Y, that is, the target point cloud X and the reference point cloud Y are subjected to local point cloud interception.

More specifically, detailed steps of step 3 are as follows:

Firstly, the to-be-evaluated point cloud map is subjected to local map interception, as the original three-dimensional coordinate system transform of the point cloud sample relative to the navigation coordinate system is known, a sphere is drawn by selecting a corresponding position of a translation amount of the original three-dimensional coordinate system transform as a center of the sphere and a radius as 25 m, all points in the sphere are intercepted out, and a local to-be-evaluated point cloud map is obtained. Then it is necessary to locally intercept the point cloud samples, a sphere is drawn by selecting an origin as a center of the sphere and a radius of 25 m in the same way, all points in the sphere are intercepted out, and local point cloud samples are obtained.

Then, it is also necessary to provide a good initial three-dimensional coordinate system transform for the NDT algorithm. In order to reduce the influence of the original three-dimensional coordinate system transform on a final matching result as much as possible, the same point cloud sample is subjected to a plurality of times of matching alignment by using different initial three-dimensional coordinate system transforms, and finally a mean of a plurality of estimated coordinate system transforms is taken as an estimated three-dimensional coordinate system transform. In consideration that the point clouds are mostly collected by the vehicle, eight initial three-dimensional coordinate system transforms are obtained in total by applying translation offset in a horizontal direction and rotation offset in an up direction to the original three-dimensional coordinate system transform, specifically as shown in FIG. 2. Positions of the eight initial three-dimensional coordinate system transforms in the figure are made to be distributed at positions 5 m deviating from four directions of east, south, west and north of the original three-dimensional coordinate system transform, and there are two initial three-dimensional coordinate system transforms at each position, which are positive rotation by 15 degrees and negative rotation by 15 degrees in the up direction.

Then, after the point cloud sample is subjected to the eight initial three-dimensional coordinate system transforms, it is matched with the local to-be-evaluated point cloud map by the NDT. Wherein, the point cloud sample is the target point cloud X in the NDT algorithm, and the local to-be-evaluated point cloud map is the reference point cloud Y in the NDT algorithm.

More specifically, in step 4, the point cloud matching errors, namely matching scores score(p) in the NDT algorithm, are obtained by calculation with the sum of probabilities as the index, and thus, finally, the NDT matched matching scores score(p) obtained by transformation over the eight initial three-dimensional coordinate system transforms are averaged, to obtain the point cloud matching errors. More specifically, the point cloud matching errors obtained in step 4 describe the sum of probabilities that each point in the point cloud sample forms the normal distribution in grids in the to-be-evaluated point cloud map nearby it. The smaller the sum of probabilities, the larger the offset of the local of the to-be-evaluated point cloud map from the local of the actual map. Thus, it can be shown that the point cloud matching errors obtained in step 4 essentially describe the local quality evaluation scores of the to-be-evaluated point cloud map

More specifically, in step 5 of calculating the quality evaluation score of the to-be-evaluated point cloud map, in consideration that the point cloud matching errors are obtained by calculation based on the sum of probabilities, a further normalization step is not needed accordingly, and the sum of probabilities can be directly used as a final quality evaluation score, namely

$$QA = {d}_{{NDT}_{- TOTAL}} .$$

### Where,

$${d}_{{NDT}_{{}_{TOTAL}}} = \frac{1}{{N}_{p}} {\sum }_{i = 1}^{{N}_{p}} {d}_{i} ,$$

and dᵢ is the point cloud matching error between each point cloud sample and the to-be-evaluated point cloud map. According to a calculation formula, the smaller the point cloud matching error, the larger the quality evaluation score, and the higher the quality of the map.

Therefore, the method for evaluating the quality of the point cloud map based on matching provided by the present disclosure can evaluate the quality of the point cloud map in a full-automatic manner without the dependence on truth values and artificial calibration, so as to improve the quality evaluation efficiency of the point cloud map; the method is low in calculation complexity, and can rapidly and effectively evaluate the quality of the point cloud map; and the method can simulate the process of positioning by using the point cloud map and reflect the quality of mapping from the final positioning effect of the map.

Finally, it should be noted that the above embodiments serve only to illustrate the technical solutions of the present disclosure and not to limit the same; although the present disclosure has been described in detail with reference to the preferred embodiments, it should be understood by a person of ordinary skill in the art that the technical solutions of the present disclosure can still be amended or equivalently replaced; and these amendments or equivalent replacements should not make the amended technical solutions deviate from the spirit and scope of the technical solutions of the present disclosure.

What is claimed is:

1. A method for evaluating a quality of a point cloud map based on matching, comprising the following steps:
S1, acquiring a to-be-evaluated point cloud map as a point cloud matching algorithm input;
S2, acquiring a point cloud sample set for matching;
S3, specific to each point cloud sample in the point cloud sample set, making the point cloud sample matched with the to-be-evaluated point cloud map by a point cloud matching algorithm, and obtaining an estimated three-dimensional coordinate system transform by an iteration with an original three-dimensional coordinate system transform as an initial value;
S4, calculating point cloud matching errors; and
S5, calculating a quality evaluation score of the to-be-evaluated point cloud map as a point cloud matching algorithm output.

2. The method according to claim 1, wherein the to-be-evaluated point cloud map is a point cloud, wherein a coordinate system for the point cloud is a navigation coordinate system;
the step of acquiring the to-be-evaluated point cloud map comprises the following steps: collecting point cloud data by a mobile mapping vehicle equipped with a plurality of sensors comprising a global positioning system (GPS), an inertial measurement unit (IMU) and a mechanical rotary Lidar, moving along a road, and establishing/acquiring the to-be-evaluated point cloud map; and
the point cloud data comprises a GPS positioning result, an IMU mapping result and a mechanical rotary Lidar scanning result, and data collected by sensors comprising an electronic compass, a wheel odometer and a barometer are further allowed to be added according to actual situations.

3. The method according to claim 1, wherein each element in the point cloud sample set consists of a point cloud sample and an original three-dimensional coordinate system transform;
coordinate systems of the point cloud samples are Lidar coordinate systems, and a quantity of points of the point cloud samples is less than a quantity of points of the to-be-evaluated point cloud map; and
the Lidar coordinate systems refer to sensor coordinate systems where the point cloud data collected by the mechanical rotary Lidar is located.

4. The method according to claim 1, wherein the original three-dimensional coordinate system transforms briefly describe a transform relation between Lidar coordinate systems where the point cloud samples are located and a navigation coordinate system.

5. The method according to claim 1, wherein the point cloud matching algorithm input is two point clouds, and the point cloud matching algorithm output is an estimated transform relation between two point cloud coordinate systems; and
the point cloud matching algorithm input is the point cloud samples and the to-be-evaluated point cloud map; and the point cloud matching algorithm output is an estimated transform relation between Lidar coordinate systems where the point cloud samples are located and a navigation coordinate system.

6. The method according to claim 1, wherein the point cloud matching errors are quantitatively-evaluated overlap degrees between the point cloud samples subjected to the estimated three-dimensional coordinate system transforms and the to-be-evaluated point cloud map.

7. The method according to claim 1, wherein the quality evaluation score is obtained by calculating a mean of the point cloud matching errors corresponding to all the point cloud samples, and normalizing the mean.

8. A method for extracting point cloud samples from a point cloud map by simulation, comprising the following steps:
1) simulating a field mapping process, and performing a simulation extraction at an equal interval in a to-be-evaluated point cloud map along a route where a mobile mapping vehicle collects data, to form a series of original three-dimensional coordinate system transforms;
2) establishing a Lidar coordinate system at each of the original three-dimensional coordinate system transforms;
3) consulting a product manual according to a model of a to-be-simulated Lidar, to obtain corresponding product parameters;
4) obtaining an azimuth angle and a pitching angle of each point in the point cloud samples according to the product parameters, and
5) calculating a distance between each point and an origin of the corresponding Lidar coordinate system according to the azimuth angle and the pitching angle of each point in the point cloud samples, to form the point cloud samples.

9. The method according to claim 8, wherein in the step of calculating the distance between cach to-be-solved point and the origin of the corresponding Lidar coordinate system, the distance is allowed to reflect a distance obtained by corresponding laser ranging in an actual map by simulation, and the following steps are as follows:
a, obtaining a cone by taking a horizontal resolution angle and a vertical resolution angle of the to-be-simulated Lidar as field angles and the azimuth angle and the pitching angle where the to-be-solved point is located as a center;
b, intercepting all points out of the cone in a to-be-evaluated map;
c, performing spatial clustering on a set formed by points intercepted by a density-based spatial clustering of applications with noise (DBSCAN) algorithm;
d, projecting each point set obtained after clustering onto a plane perpendicular to azimuth rays of the azimuth angle and the pitching angle where the to-be-solved point is located;
e, performing a solution to obtain a two-dimensional convex hull of the projection of each point set obtained after clustering;
f, screening out convex hulls not containing projection points of rays from the two-dimensional convex hulls of all point cloud projections;
g, obtaining a convex hull, closest to the origin of the Lidar coordinate system, of a gravity center of a corresponding three-dimensional point set from the rest of convex hulls by a calculation; and
h, calculating a distance between a gravity center of the three-dimensional point set and the origin of the Lidar coordinate system in a ray direction as a final simulation extraction point distance according to the three-dimensional point set corresponding to a unique selected convex hull.

10. An application method of the method according to claim 8 in acquiring a point cloud sample set.
